(19) United States
(12) Patent Application Publication
(10) Pub. No.: US 2024/0270486 A1
(43) Pub. Date: Aug. 15, 2024

(54) ODORLESS DIAPER BIN

(71) Applicant: Momentum Product Solutions, LLC, Lake Hopatcong, NJ (US)

(72) Inventors: Matthew B. Morrison, Lake Hopatcong, NJ (US); Gerald Garavuso, Rochester, NY (US); Morgan Shine, Newberg, OR (US); Patrick Santorella-Doyle, Randolph, NJ (US); Sarah Loucks, Syracuse, NY (US); Nathan Durham, Olean, NY (US); Hamza Khammash, Amman (JO)

(21) Appl. No.: 18/384,514

(22) Filed: Oct. 27, 2023

Related U.S. Application Data
(63) Continuation of application No. PCT/US2022/026140, filed on Apr. 25, 2022.
(60) Provisional application No. 63/182,306, filed on Apr. 30, 2021.

(51) Int. Cl. B65F 1/06

(52) U.S. Cl. CPC B65F 1/062; B65F 2210/167; B65F 2210/188; B65F 2240/132

(57) ABSTRACT

A waste containment or disposal device is provided comprising a sleeve source for providing a continuous flexible sleeve, a sealing mechanism for permanently sealing a segment of the continuous flexible sleeve, and a feed mechanism for advancing a length of the continuous flexible sleeve past the sealing mechanism. Upon placement of waste in a segment of the continuous flexible sleeve having a closed end advanced past the sealing mechanism by the feed mechanism, the sealing mechanism permanently seals the segment of the flexible sleeve. Also provided is a method for containing or disposing of waste.

### CROSS REFERENCE TO RELATED APPLICATIONS

This application is a continuation of International Patent Application No. PCT/US2022/026140, filed Apr. 25, 2022, which takes priority from U.S. Provisional Application No. 63/182,306, filed Apr. 30, 2021, the contents of each of which are incorporated by reference herein.

### FIELD OF THE INVENTION

The present invention relates to waste disposal devices for odorless containment and/or disposal of waste, namely diapers.

### BACKGROUND

In households having infants or young children in which disposable diapers are used, a designated diaper pail is often used for disposal of soiled diapers. On average, newborn babies go through 8 to 12 diapers in a single day. Designated diaper receptacles make it easy for new parents to change their child's diapers quickly throughout the course of the day without several trips to a dumpster and without rapidly filling up or making large messes in their household garbage cans.

However, such diaper bins containing soiled diapers can develop a distinct and potent odor in the room in which they are located. As such, many attempts have been made to reduce the odor emanating from such diaper bins. For example, existing designs may focus on sealing an opening of the diaper bin, such that an odor is largely sealed in, so long as the bin is closed. However, such bins emit a concentrated odor when opened. Some existing designs further focus on covering up an odor emanating from the bin using air fresheners and the like. However, such approaches are insufficient.

Some designs further rely on twisting a flexible sleeve after depositing diapers, such that diapers are located in independent twisted pouches. However, because such pouches are merely twisted, they tend to open up when a user tries to dispose of them. Further, such a twist can result in use of large stretches of plastic, thereby resulting in significant plastic waste.

There is a need for a waste disposal device and method that utilizes a mechanism that can permanently prevent the escape of odors after depositing diapers into a bin. It is noted that while the device described herein is discussed in terms of diaper containment and disposal, the device may be used to contain or dispose of other forms of waste as well.

### SUMMARY

A waste containment or disposal device is provided comprising a sleeve source for providing a continuous flexible sleeve, a sealing mechanism for permanently sealing a segment of the continuous flexible sleeve, and a feed mechanism for advancing a length of the continuous flexible sleeve past the sealing mechanism. Upon placement of waste in a segment of the continuous flexible sleeve having a closed end advanced past the sealing mechanism by the feed mechanism, the sealing mechanism permanently seals the segment of the flexible sleeve.

In some embodiments, the continuous flexible sleeve comprises a fusible material. The sealing mechanism may then permanently seal the segment by fusing the fusible material.

In some such embodiments, the sealing mechanism comprises a clamp and a heat source. Accordingly, upon placement of the waste in the segment, the clamp compresses an opening of the segment against the heat source, and the heat source applies heat to fuse the clamped fusible material.

In some embodiments, the continuous flexible sleeve comprises a fusible plastic. The sealing mechanism then melts an opening of the segment closed by applying heat to the fusible plastic.

In some embodiments, the feed mechanism comprises an inner tube and at least one outer roller. A cross section of the continuous flexible sleeve encloses the inner tube, and the at least one outer roller grips the continuous flexible sleeve and the feed mechanism rotates the at least one outer roller to advance the continuous flexible sleeve relative to the inner tube.

In some such embodiments, the at least one outer roller is motorized, and after permanently sealing the segment of the flexible sleeve to form a sealed segment, the at least one outer roller advances the continuous flexible sleeve so as to locate a new segment of the flexible sleeve between the sealed segment and the sealing mechanism.

In some such embodiments, the at least one outer roller advances the continuous flexible sleeve so as to locate the new segment only after determining that a lid of the waste disposal device has been opened.

In some embodiments, the feed mechanism comprises a cartridge support. The sleeve source is then provided as a cartridge and is located at the cartridge support. The continuous flexible sleeve is then drawn from the cartridge by the feed mechanism.

In some embodiments, the device includes at least one sensor for determining when waste has been deposited into the segment of the continuous flexible sleeve.

In some embodiments, the device includes a container defining a waste receiving chamber located such that a sealed segment advanced past the sealing mechanism is received in the waste receiving chamber.

In some such embodiments, the sleeve source, sealing mechanism, and feed mechanism are all located within the container. The waste disposal device further comprises a lid for sealing to the container and enclosing the sleeve source, sealing mechanism, and feed mechanism.

In some such embodiments, the device further includes a compacting mechanism. The compacting mechanism compacts waste into the segment upon closure of the lid.

In some embodiments, the device includes at least one interlock preventing the sealing mechanism from sealing the segment unless the lid is closed.

In some embodiments, the device includes a vacuum assembly for extracting air from the segment prior to or during sealing of the segment by the sealing mechanism.

In some embodiments, the sleeve source is located opposite the sealing mechanism from the feed mechanism. During use, the feed mechanism draws the continuous flexible sleeve past the sealing mechanism.

In some embodiments, the sealing mechanism applies pressure to fuse the fusible material. In such embodiments, upon placement of the waste in the segment, the sealing mechanism compresses an opening of the segment to fuse the fusible material.

Also provided is a method for containing or disposing of waste. The method includes providing a continuous flexible sleeve having a sealed end, providing a sealing mechanism for sealing the continuous flexible sleeve, and providing a feed mechanism for advancing a length of the continuous flexible sleeve past the sealing mechanism.

The method then determines that waste has been deposited within the continuous flexible sleeve adjacent the sealed end and permanently seals, by the sealing mechanism, an end of a segment of the continuous flexible sleeve between the sealing mechanism and the sealed end, thereby forming a newly sealed end. The method then proceeds with advancing the continuous flexible sleeve by the feed mechanism such that the newly sealed end is spaced apart from the sealing mechanism by a new segment.

In some embodiments, the continuous flexible sleeve comprises a fusible material. Permanently sealing the end of the segment of the continuous flexible sleeve comprises clamping the end of the segment against a heat source and applying heat to the fusible material at the heat source.

In some embodiments, the feed mechanism comprises an inner tube and at least one outer roller. A cross section of the flexible sleeve may then enclose the inner tube and advancing the continuous flexible sleeve includes gripping the flexible sleeve at the at least one outer roller and sliding the flexible sleeve relative to the inner tube.

In some such embodiments, determining that waste has been deposited is by detecting waste passing a sensor at the inner tube.

In some embodiments, the feed mechanism is located opposite the sealing mechanism from the segment, such that the feed mechanism dispenses the continuous flexible sleeve towards and past the sealing mechanism.

In some embodiments, the continuous flexible sleeve comprises a pressure fusible material. Permanently sealing the end of the segment then comprises applying pressure to the fusible material.

### BRIEF DESCRIPTION OF THE DRAWINGS

FIG. 1 is a view of a waste disposal device in accordance with this disclosure in a closed configuration.

FIG. 2A is a sectioned view of a waste disposal device in accordance with FIG. 1 of this disclosure.

FIG. 2B is a second sectioned view of the waste disposal device of FIG. 1.

FIG. 3 is a perspective view of the waste disposal device of FIG. 1 with a lid open.

FIG. 4A is a perspective view of a feed mechanism for use in the waste disposal device of FIG. 1.

FIG. 4B is a top view of the feed mechanism of FIG. 4A.

FIG. 5 is a sectioned view of the feed mechanism of FIG. 4A taken along line 5-5 in FIG. 4B.

FIG. 6 is a perspective view of the feed mechanism of FIG. 4 paired with a sealing mechanism for use in the waste disposal device of FIG. 1.

FIG. 7 is a perspective view of a sealing mechanism for use in the waste disposal device of FIG. 1 in an open configuration.

FIG. 8 is a top view of the sealing mechanism of FIG. 7.

FIG. 9 is a side sectioned view of the sealing mechanism of FIG. 7 taken along line 9-9 in FIG. 8.

FIG. 10 is a perspective view of the sealing mechanism of FIG. 7 in a closed configuration.

FIG. 11 is a side view of an alternative embodiment of a feed mechanism for use in a waste disposal device.

FIG. 12 is a top perspective view of an alternative embodiment of a feed mechanism for use in a waste disposal device.

FIG. 13 is a view of a roller configuration for use in the feed mechanism of FIG. 12.

FIG. 14 is an alternative embodiment of a waste disposal device in accordance with this disclosure with structural support removed.

FIG. 15 provides a flowchart showing a method for disposing of waste.

FIGS. 16A-D illustrate the method for disposing of waste in the context of the waste disposal device of FIG. 1.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

This disclosure relates to a device for containing and disposing of waste, such as diapers. It is understood that while the description provided herein refers to the device as a disposal device, the device may similarly be used for containment. Accordingly, waste, such as a diaper, may be placed into the device after which it is contained by the device. After that point, the contained waste may be disposed of.

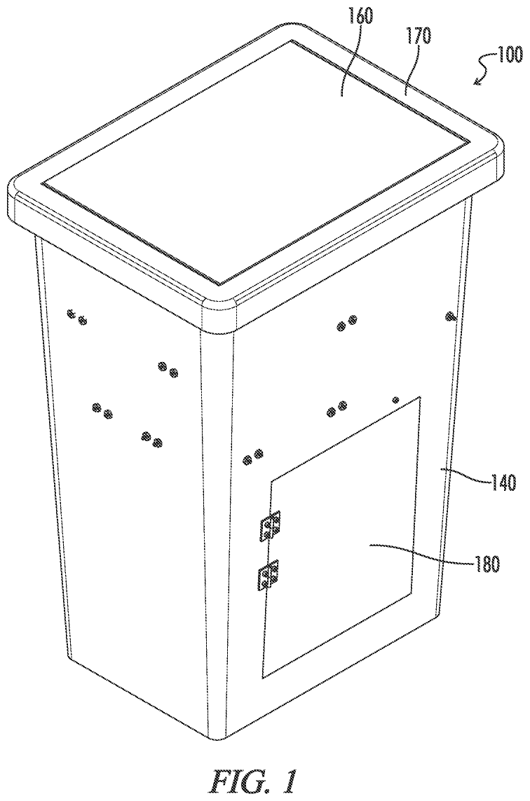

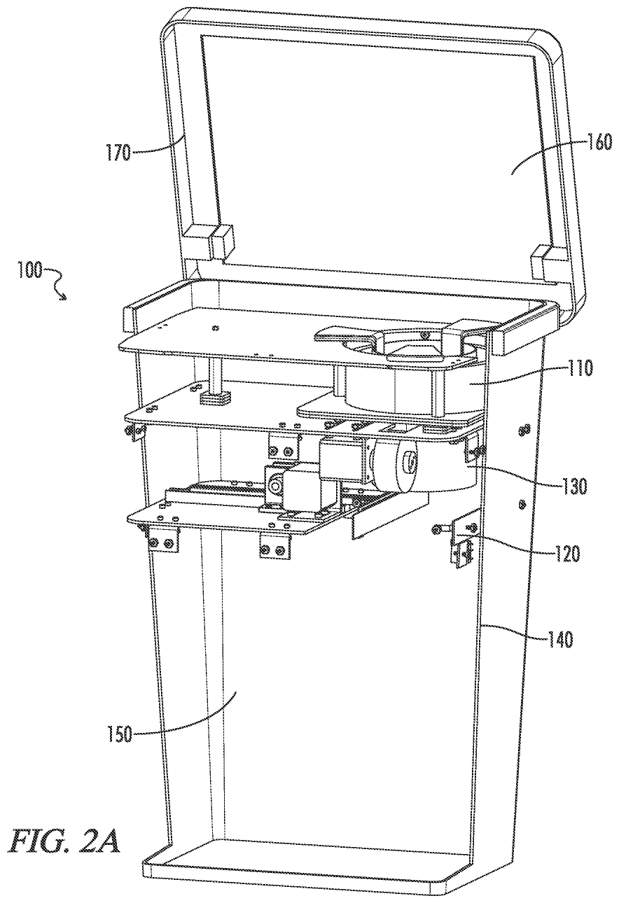

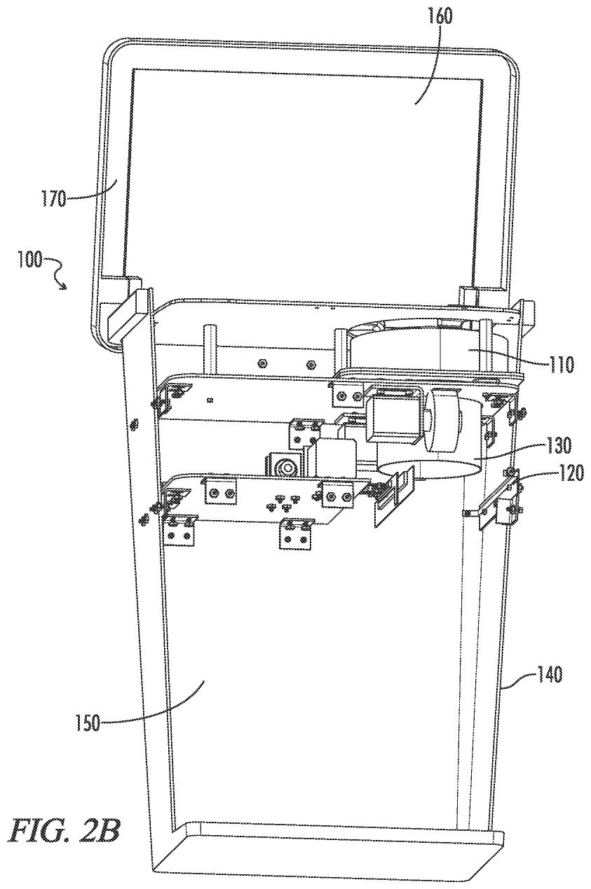

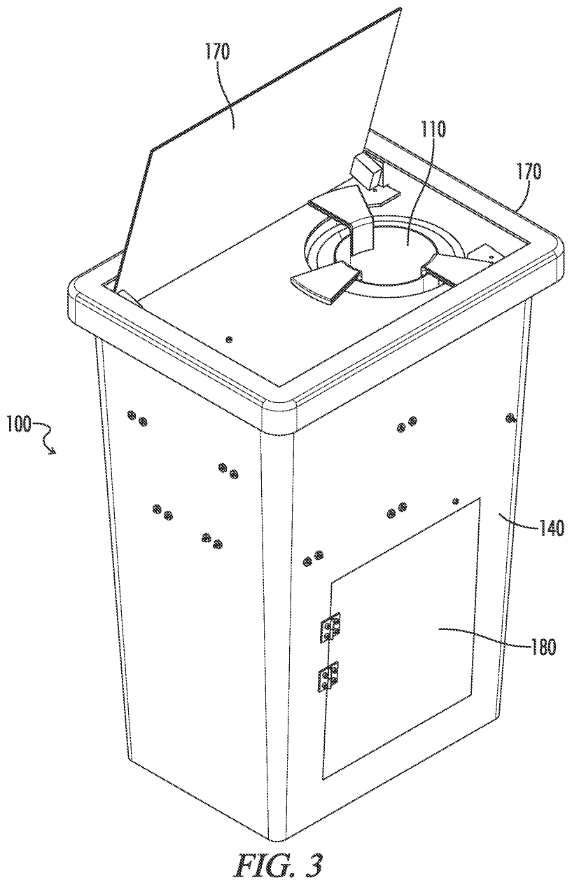

FIG. 1 is a view of a waste disposal device 100 in accordance with this disclosure, and FIGS. 2A and 2B are sectioned views of the waste disposal devices 100 of FIG. 1. FIG. 3 is a perspective view of the waste disposal device 100 of FIG. 1. As shown, the waste disposal device 100 has a sleeve source 110 for providing a continuous flexible sleeve, a sealing mechanism 120, and a feed mechanism 130. The sealing mechanism 120 is for permanently sealing a segment of the continuous flexible sleeve, and the feed mechanism 130 is for advancing a length of the continuous flexible sleeve past the sealing mechanism 120.

In use, the continuous flexible sleeve initially has a closed end, and extends past the sealing mechanism 120. The components would typically be arranged vertically, as shown, so the continuous flexible sleeve would be suspended from above the sealing mechanism 120 and arranged such that the closed end hangs below the sealing mechanism. The continuous flexible sleeve thereby forms a pouch which hangs below the sealing mechanism 120 with a segment of the sleeve between the closed end and the sealing mechanism 120.

Upon placement of waste in the segment adjacent the closed end of the continuous flexible sleeve, the sealing mechanism 120 permanently seals the segment of the flexible sleeve. After sealing the segment by the sealing mechanism 120, the feed mechanism 130 advances the continuous flexible sleeve such that a newly sealed end of the segment forms a new closed end, and such that a new segment of the sleeve is located between the new closed end and the sealing mechanism.

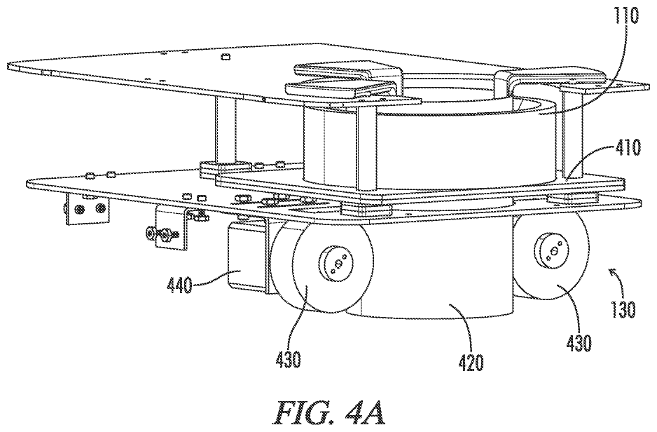

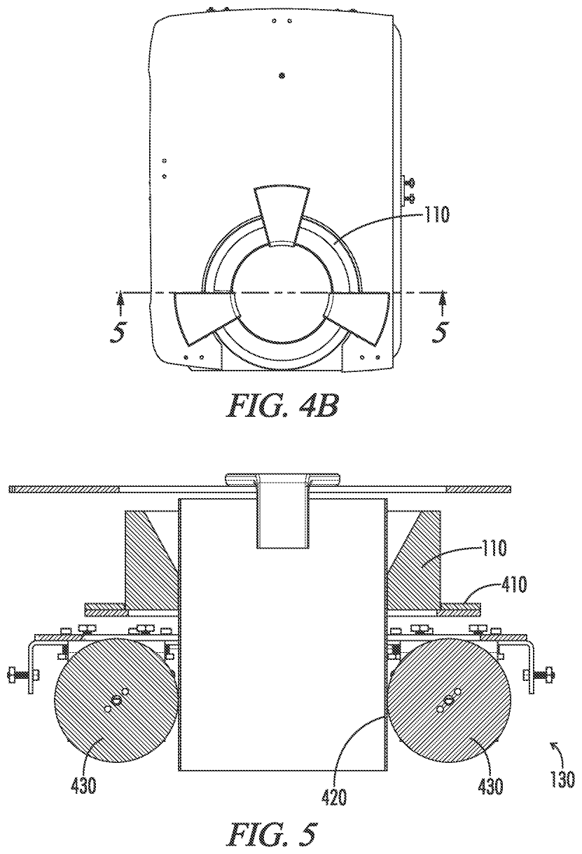

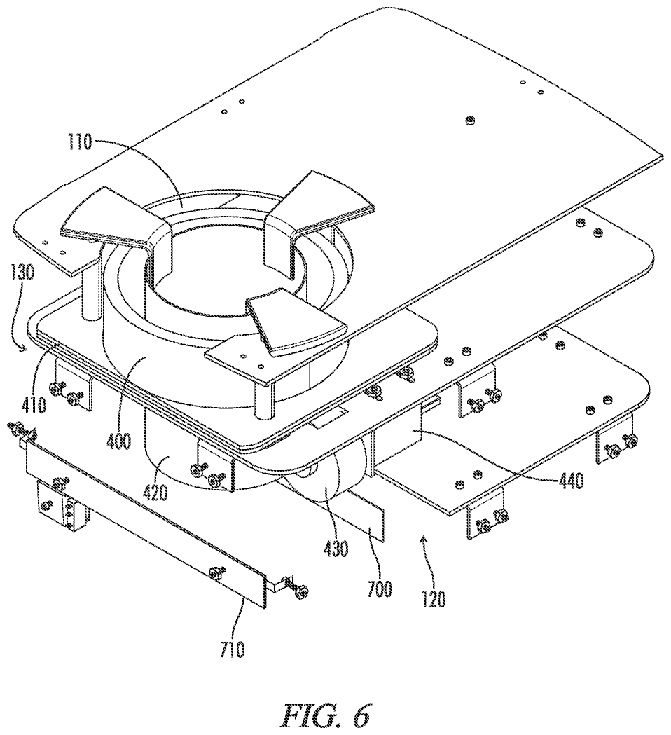

FIG. 4A is a perspective view of a sleeve source 110 and feed mechanism 130 for use in the waste disposal device 100 of FIG. 1. FIG. 4B is a top view of the sleeve source 110 and feed mechanism 130 of FIG. 4A. FIG. 5 is a sectioned view of the feed mechanism 130 and sleeve source 110 of FIG. 4A taken along line 5-5 of FIG. 4B. As shown, the feed mechanism may be paired with the sleeve source 110. The sleeve source 110 may be a cartridge taking the form of a ring of bags 400, and the feed mechanism 130 may comprise a cartridge support 410.

The continuous flexible sleeve may be formed from a fusible material, such as a fusible plastic, and the sealing mechanism 120 may then permanently seal the segment by fusing the fusible material. While this will be discussed in more detail below, the sealing mechanism 120 may therefore comprise a heat source for partially melting or otherwise fusing the fusible material. Alternative embodiments are contemplated as well, such that the sealing mechanism applies pressure sufficient to fuse the material.

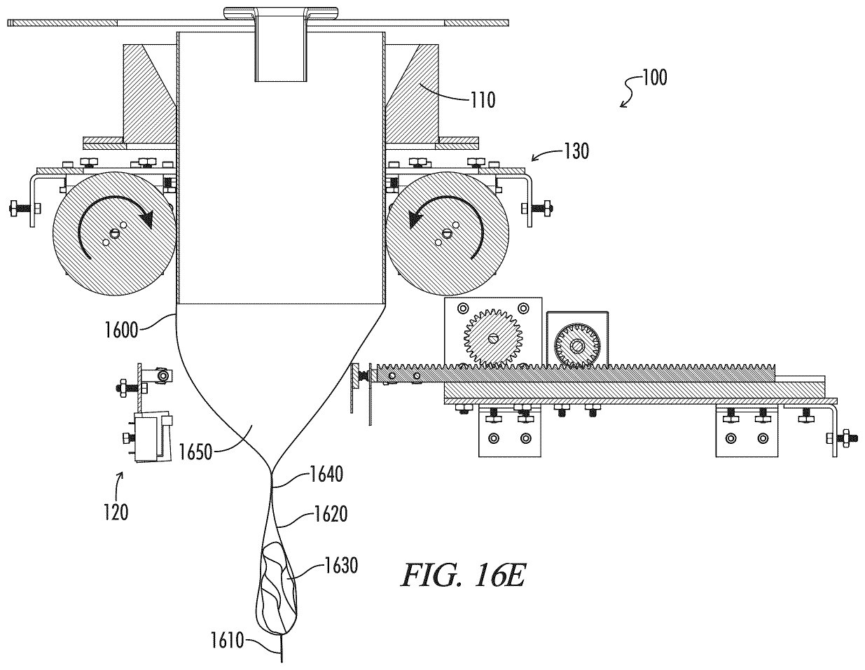

As shown, the feed mechanism 130 may have an inner tube 420 and at least one outer roller 430. During use, a length of the continuous flexible sleeve would then extend from the sleeve source 110 and a cross section of the sleeve would fully enclose the inner tube 420. The at least one outer roller 430 would then grip the continuous flexible sleeve relative to the inner tube 420 and the feed mechanism 130 would rotate the roller to advance the sleeve relative to the inner tube. This is shown in more detail below with respect to FIGS. 16A-E.

A motor 440 may be provided to drive the at least one outer roller 430. During use, after permanently sealing the segment of the permanent flexible sleeve to form a sealed segment at the sealing mechanism 120, the at least one outer roller 430 rotates to advance the continuous flexible sleeve so as to locate a new segment of the flexible sleeve between the sealed segment and the sealing mechanism 120.

It will be understood that alternative feed mechanisms are contemplated as well. In some embodiments, the feed mechanism comprises the cartridge support as shown and the sleeve source is a cartridge located at the cartridge support. In such embodiments, the continuous flexible sleeve is drawn from the cartridge by the feed mechanism.

In alternative embodiments, the sleeve source may be separated from the feed mechanism. For example, the feed mechanism may be located below the sealing mechanism, such that the feed mechanism pulls the continuous flexible sleeve from the sleeve source and past the sealing mechanism. In such an embodiment, the feed mechanism may be located opposite the sealing mechanism from the feed mechanism.

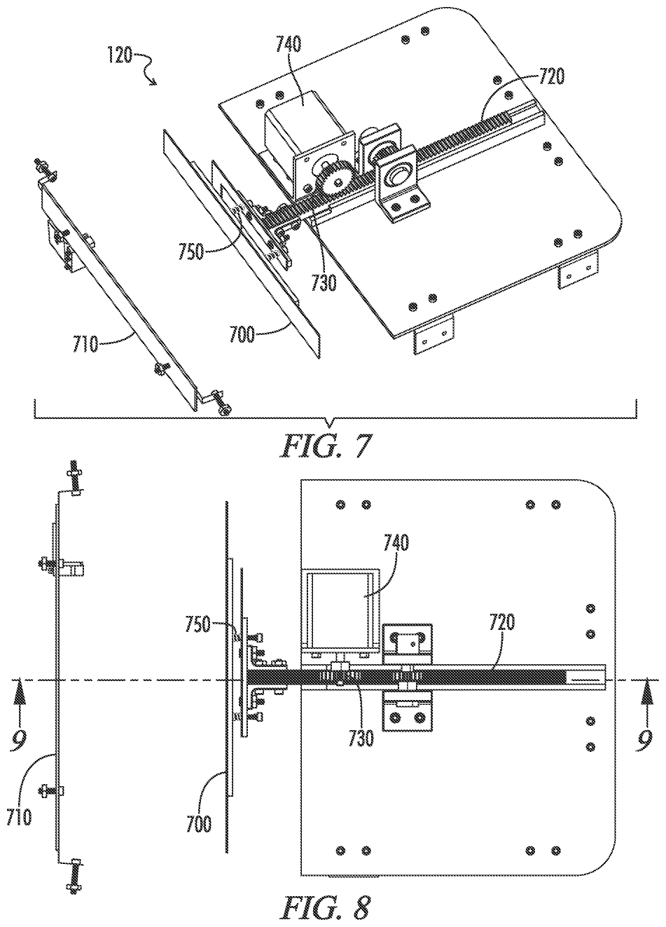

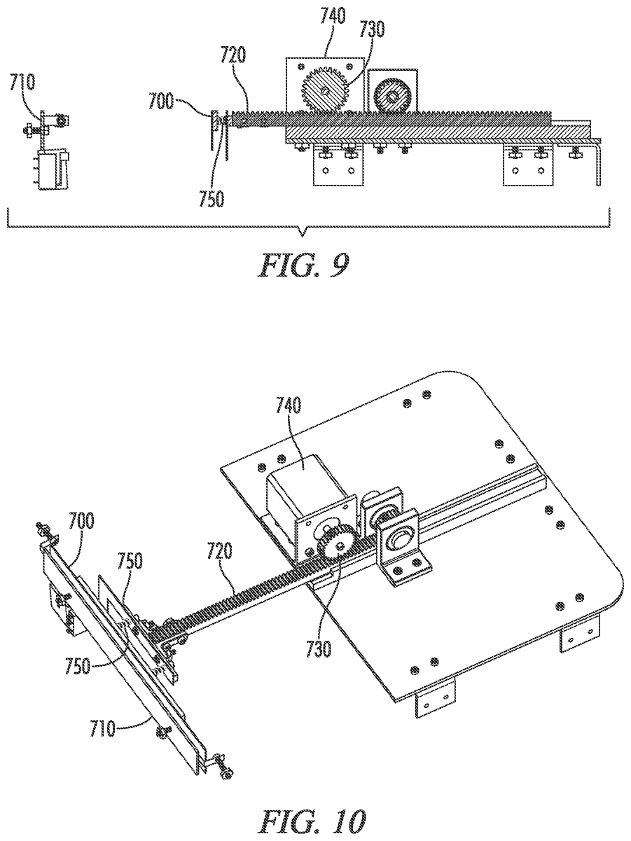

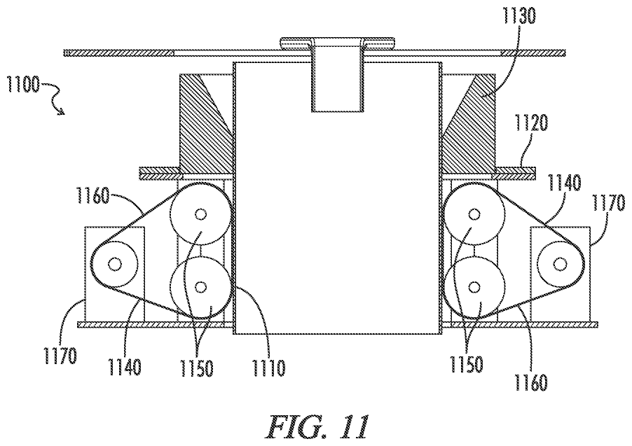

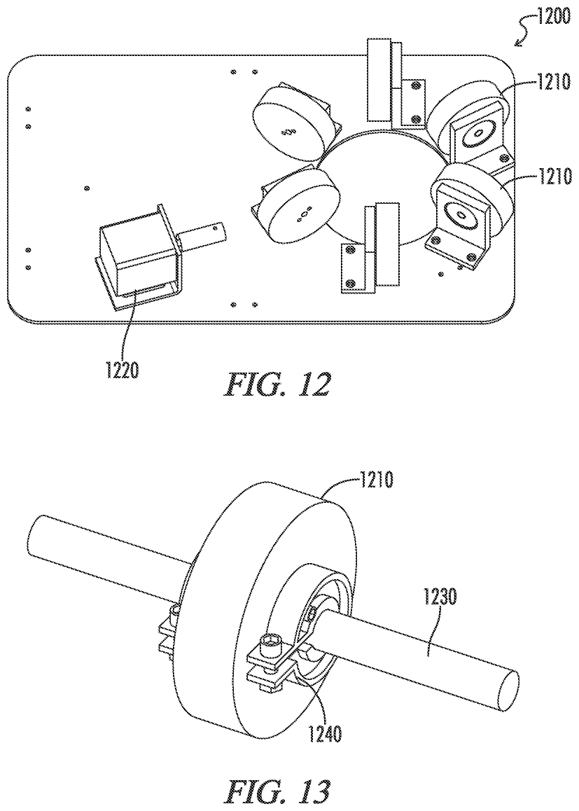

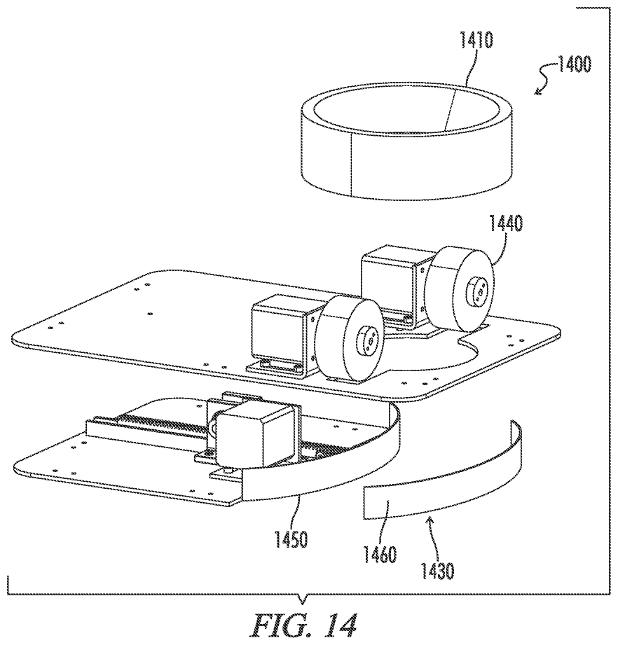

FIG. 6 is a perspective view of the feed mechanism 130 of FIG. 4 paired with a sealing mechanism 120 for use in the waste disposal device 100 of FIG. 1. FIG. 7 is a perspective view, FIG. 8 is a top view, and FIG. 9 is a side sectioned view of a sealing mechanism 120 for use in the waste disposal device 100 of FIG. 1 in an open configuration taken along line 9-9 of FIG. 8. FIG. 10 is a different perspective view of the sealing mechanism 120 of FIG. 7 in a closed configuration.

As shown, where the continuous flexible sleeve comprises a fusible material, the sealing mechanism 120 can permanently seal segments of the flexible sleeve by fusing the material. In some such embodiments, the sealing mechanism 120 comprises a clamp 700 and a heat source 710. When waste is placed in the segment of the continuous flexible sleeve, the clamp 700 then compresses an opening of the segment against the heat source 710 and the heat source applies heat to fuse the clamped fusible material. For example, the flexible sleeve may comprise a fusible plastic, and the sealing mechanism 120 may then melt an opening of the segment closed by applying heat to the fusible plastic. In this way, the segment may be permanently sealed.

While the embodiments discussed here may refer to the flexible sleeve as fusible plastic fused by heat, it is understood that in some embodiments, the flexible sleeve may be fused by pressure, as noted below, or it may be formed of other materials. Such other materials may be fusible, as discussed herein, or may be otherwise prepared for sealing. For example, a flexible sleeve formed from a different material, such as paper, may be provided with a sealing element, such as an adhesive. Such an adhesive may be applied to an interior of the flexible sleeve by the device, or such an adhesive may be applied prior to use. For example, a paper sleeve may be provided and coated with a pressure activated adhesive.

In some embodiments, the clamp 700 may be actuated using a rack 720 and pinion 730 in order to apply force to the continuous flexible tube. The pinion may be driven by a motor 740, and may be actuated upon detection of waste being deposited in the segment of the continuous flexible tube. Such detection may be by way of a sensor, which may be configured to detect the weight of waste located in the segment, or may be an optical sensor, or some other sensor, located in the inner tube 420, such that any waste passing through the inner tube is detected and triggers an actuation of the sealing mechanism 120.

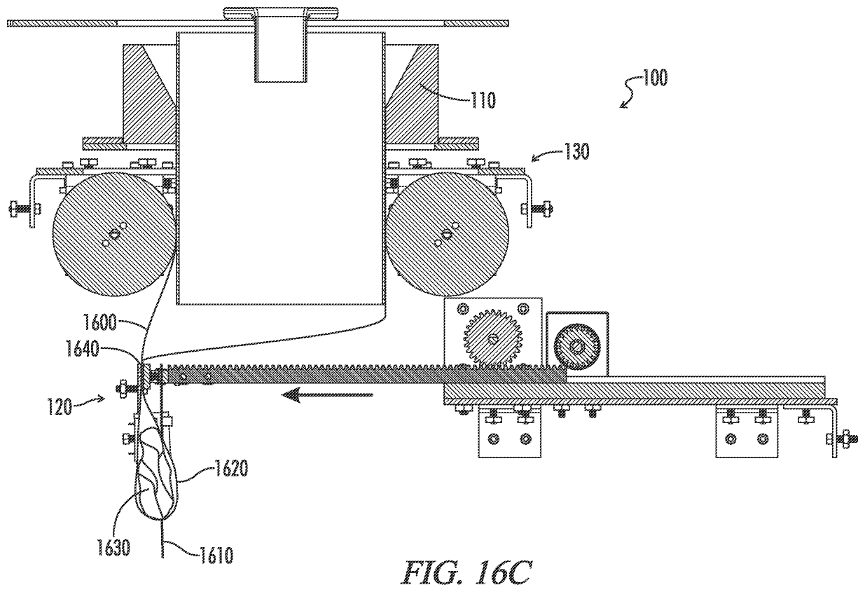

The clamp 700 of the sealing mechanism 120 may be spring loaded using springs 750 which may thereby ensure even pressure applied to the continuous flexible tube, even in the event of uneven folding of such tube during compression against the heating element 710. The clamp itself 700 may comprise a heat resistant material, such as a high temperature rubber, and the heating element 710 may be stationary and may comprise a resistance-based heating element, such as a nichrome element. In some embodiments, the heating element 710 may be shaped in order to provide a better seal. As such, the heating element 710 may be provided with curvature, as shown in the embodiment of FIG. 14, for example, to ensure that edges of the continuous flexible sleeve are heated, and in some embodiments matching curvature may be provided in the clamp 700.

It will be understood that while a specific sealing mechanism is shown and described, alternative embodiments are contemplated as well. In some such embodiments, the sealing mechanism may apply pressure without applying heat. In such an embodiment, upon placement of the waste in the segment, the sealing mechanism compresses an opening of the segment to fuse the fusible material. Such a mechanism may apply pressure by way of a clamp, such as that shown. Accordingly, the clamp may rest against a bracing surface, where the bracing surface does not provide heat.

Similarly, in the clamping mechanism, alternative actuators are contemplated as well. As such, the rack and pinion actuator shown may be replaced by any number of linear actuators.

In some embodiments, the sealing mechanism may be integrated into a single unit with the feed mechanism, such that a single mechanism may advance the flexible sleeve and seal the sleeve simultaneously. For example, a rotary seal wheel may be provided that seals the flexible sleeve and indexes as it rotates. Such a rotary seal wheel may be a wheel with an extension configured to apply pressure to a sealing surface, such as the heating element discussed above. Such a wheel may be further configured to grip the flexible sleeve, such that the wheel dispenses the sleeve and seals it when rotated.

Returning now to FIGS. 1-3, the waste disposal device 100 may further comprise a container 140 defining a waste receiving chamber 150. The waste receiving chamber 150 is located such that when a sealed segment of the continuous flexible sleeve is advanced past the sealing mechanism 120, it is received in the waste receiving chamber 150.

The container 140 may be larger than the waste receiving chamber 150, and the sleeve source 110, sealing mechanism 120, and feed mechanism 130 may all be located within the container during use. The container 140 may thereby function as a housing for the waste disposal device 100. The waste disposal device 100 may then further comprise a lid 160 for sealing the container 140 and enclosing the sleeve source 110, sealing mechanism 120, and feed mechanism 130.

In some embodiments, the waste disposal device 100 may further comprise a compacting mechanism. Such a mechanism may compact waste into the segment of the continuous flexible sleeve upon closure of the lid 160. For example, the compacting mechanism may be a plunger that extends from the lid 160 and applies a force through the inner tube 420 when the lid is closed.

In some embodiments, various safety mechanisms may be implemented to prevent motorized activity in the waste disposal device 100 when the device is accessible. Accordingly, an interlock may be provided such that motors may not be operational unless the lid 160 is closed and the container 140 is thereby inaccessible. For example, such an interlock may prevent the provision of power to the motor or motors when the lid 160 or door 180 is open.

Similarly, an interlock may be provided to prevent the provision of power to the heating element, such that the sealing mechanism 120 may not seal the segment unless the lid 160 and/or door are closed.

In some embodiments, the lid 160 may be retained by a frame 170 that closes the container 140 and which the lid 160 rotates relative to. As such, the frame 170 may be openable with more difficulty than the lid 160, and may be designed for opening for accessing components of the disposal device 100, such as for changing a sleeve cartridge in the sleeve source 110. The lid 160 may then be opened relative to the frame 170 during general use to dispose of diapers or other waste.

The container 140 may further be provided with a door 180 through which the waste receiving chamber 150 can be accessed. Accordingly, when the waste receiving chamber is full, for example, waste may be removed from within the chamber through the door 180.

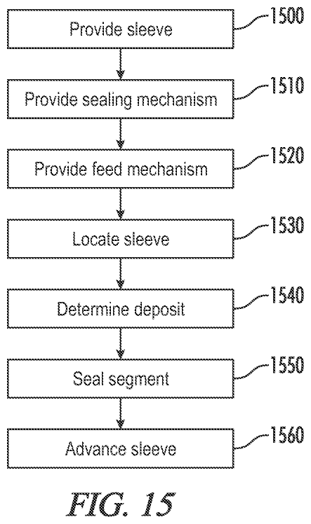

FIG. 11 is a side view of an alternative embodiment of a feed mechanism 1100 for use in a waste disposal device 100. As shown, the feed mechanism 1100 may include an inner tube 1110 and a cartridge support 1120 for supporting a sleeve source 1130. The feed mechanism further comprises at least one roller assembly 1140, each roller assembly having at least two rollers 1150. The roller assembly 1140 further includes a belt 1160 which can be applied to the rollers 1150 and driven by a motor 1170. In such an embodiment, the belt may be formed from a material selected to provide grip relative to the continuous flexible sleeve material.

Accordingly, when the waste disposal device 100 advances the continuous flexible sleeve, the feed mechanism 1100 actuates the motor 1170 in order to drive the belt 1160 which then rotates on the rollers 1150 to advance the continuous flexible sleeve relative to the inner tube 1110.

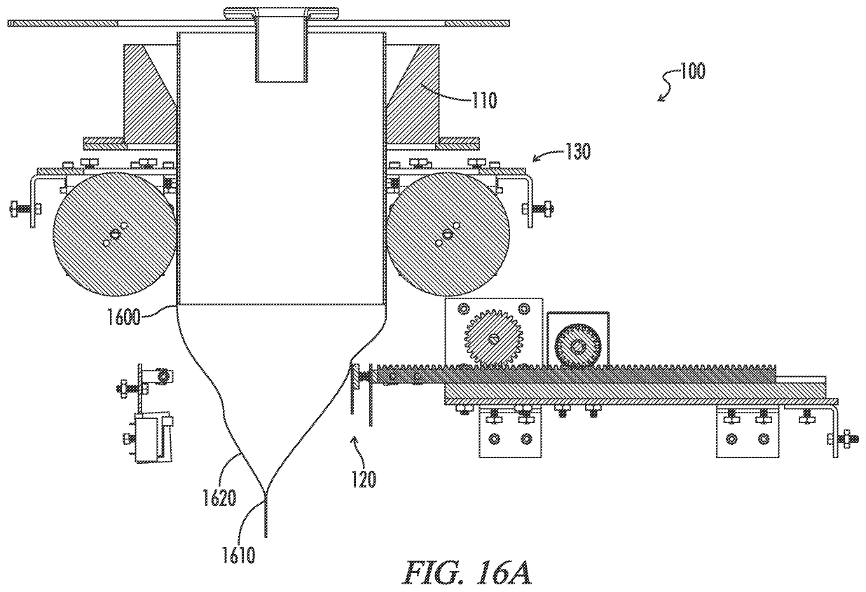

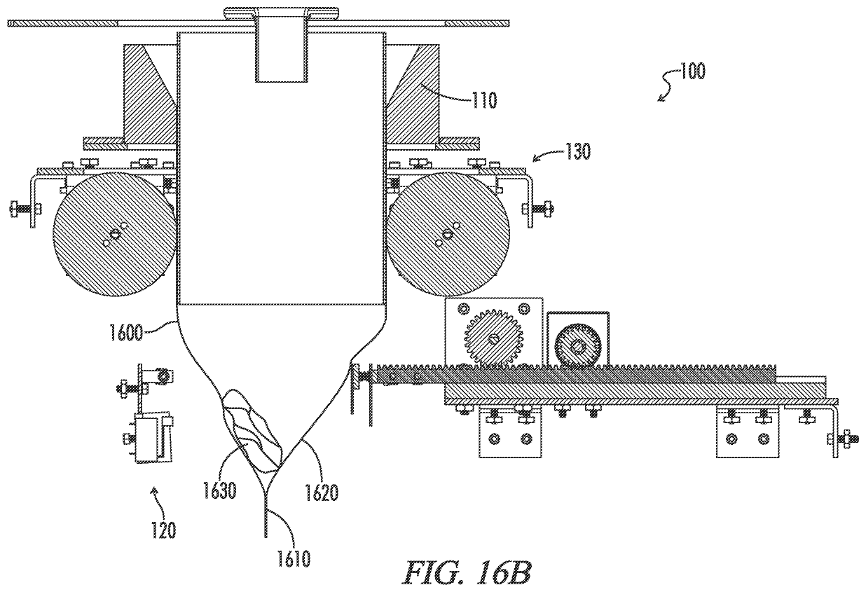

FIG. 12 is a top perspective view of an alternative embodiment of a feed mechanism 1200 for use in a waste disposal device 100. FIG. 13 is a view of a roller configuration for use in the feed mechanism 1200 of FIG. 12. As shown, a plurality of rollers 1210 may be provided about the inner tube (not shown). Each such roller 1210 may then be positioned so as to apply pressure to the inner tube by way of the continuous flexible sleeve and thereby grip the sleeve. When the rollers 1210 are rotated, the sleeve may then be advanced relative to the inner tube.

In the embodiment discussed above in FIG. 4, for example, each of the one or more rollers 430 were provided with a corresponding motor 440. In contrast, in the embodiment shown in FIGS. 12 and 13, the plurality of rollers 1210 are driven by a single motor 1220. The motor 1220 may then drive all rollers 1210 by way of a cable 1230. The cable 1230 is not shown in FIG. 12, but is shown as fixed to one of the rollers 1210 in FIG. 13.

Such a cable 1230 may then function as a flexible driveshaft. In such an embodiment, the cable 1230 may then pass through each roller 1210 and may be fixed to such rollers by way of clamps 1240. Such clamps may then ensure that each roller rotates with the cable 1230 as the cable is driven by the motor 1220.

FIG. 14 is an alternative embodiment of a waste disposal device 1400 in accordance with this disclosure. As shown, the waste disposal device 1400 has a sleeve source 1410 for providing a continuous flexible sleeve, a sealing mechanism 1430 for permanently sealing a segment of the continuous flexible sleeve, and a feed mechanism 1440 for advancing a length of the continuous flexible sleeve past the sealing mechanism.

Upon placement of waste in a segment of the flexible sleeve having a closed end advanced past the sealing mechanism 1430 by the feed mechanism 1440, the sealing mechanism permanently seals the segment of the flexible sleeve. The continuous flexible sleeve may be formed from a fusible material, such as plastic, and the sealing mechanism 1430 may apply heat to melt, and thereby fuse, the fusible material. As shown, the components of the sealing mechanism, 1430, namely the clamp 1450 and the heating element 1460, may be curved in order to improve the seal of the fusible material when fused.

In some embodiments, the waste disposal device may further comprise a vacuum assembly. Such a vacuum assembly may be configured to extract air from the segment of the continuous flexible sleeve prior to or during sealing of the segment by the sealing mechanism. In this way, the sealed segments containing waste may be vacuum sealed, so as to maintain the waste in a smaller amount of space, and thereby allowing the waste disposal device to fit more waste within the container prior to requiring a change. Further, by vacuum sealing each sealed segment, the sealed segments may be made more robust and less likely to pop when transferring the sealed segments to a separate garbage can or other trash disposal receptacle.

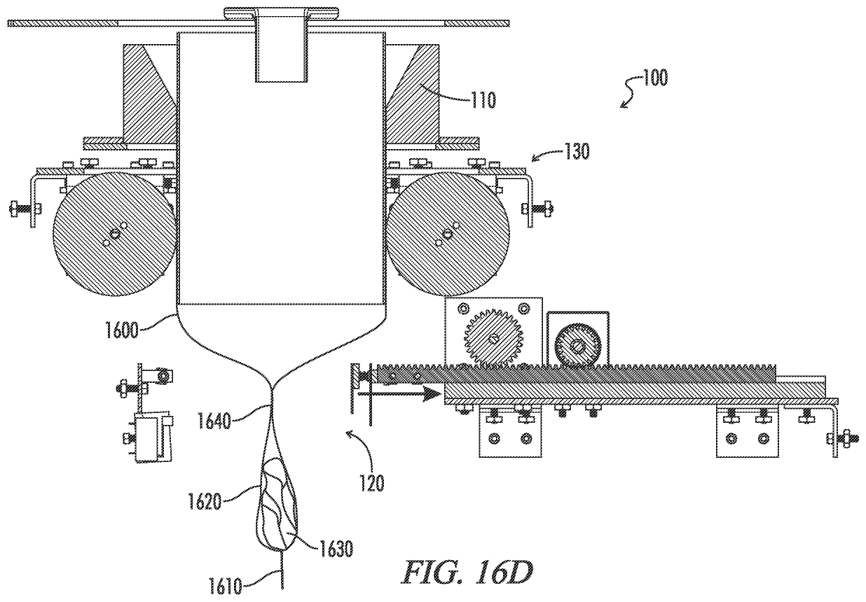

FIG. 15 provides a flowchart, and FIGS. 16A-E show schematic diagrams in the context of the waste disposal device of FIG. 1, showing a method for disposing of waste. It is noted that in the schematic diagrams of FIGS. 16A-E, the sealing mechanism 120 has been rotated relative to the feed mechanism 130, such that both components can be seen and understood more easily. It will be understood that such a rotation will not substantively impact the embodiments shown.

As shown, the method is provided in the context of a waste disposal device 100, such as that discussed above, in which a continuous flexible sleeve 1600 is provided (1500) and has a sealed end 1610. Also provided is a sealing mechanism 120 (1510) and a feed mechanism 130 (1520), where the sealing mechanism is for sealing the continuous flexible sleeve and the feed mechanism is for advancing a length of the continuous flexible sleeve pas the sealing mechanism.

Initially, the sealed end 1610 of the continuous flexible sleeve 1600 is located past the sealing mechanism 120 (1530), such that a segment 1620 of the continuous flexible sleeve is located between the closed end and the sealing mechanism. Upon determining that waste 1630 has been deposited within the continuous flexible sleeve adjacent the sealed end (1540), the method permanently seals (1550) by the sealing mechanism 120, an end 1640 of the segment of the continuous flexible sleeve 1600 between the sealing mechanism and the sealed end 1610, thereby forming a newly sealed end 1640.

The continuous flexible sleeve 1600 is then advanced (1560), such as by a feed mechanism 130, such that the newly sealed 1640 end is spaced apart from the sealing mechanism by a new segment 1650. Accordingly, the method may continue to monitor for additional waste deposited within the continuous flexible sleeve 1600 (at 154), and may then proceed to seal (at 1550) and further advance (at 1560) the sleeve.

As discussed above, the continuous flexible sleeve comprises a fusible material, and permanently sealing the end of the segment of the of the sleeve comprises clamping an end of the segment against a heat source and applying heat to the fusible material at the heat source. Such a fusible material may be a fusible plastic, for example.

The feed mechanism 130 may comprise an inner tube 420 and at least one outer roller 430, and a cross section of the continuous flexible sleeve may then enclose the inner tube. Advancing the continuous flexible sleeve (at 1560) may then comprise gripping the sleeve at the roller 430 and sliding the flexible sleeve relative to the inner tube.

Determining that waste has been deposited (at 1540) may be by utilizing a sensor, such as a weight sensor in the feed mechanism 130 or elsewhere, or by a motion sensor in the inner tube 420. Alternatively, placement of waste in the waste disposal device 100 may be by indicating such placement by, for example, closing a lid 160 of the device or by indicating at an interface that waste has been deposited.

Once the waste receiving chamber 150 is full, the chamber may be opened. This can be through the lid frame 170 by removing components of the waste disposal device 100 from above the waste receiving chamber 150, or it may be through the separate door 180 providing access directly to the chamber. Such a door 180 may be provided in a wall of the chamber 150. Similarly, once the continuous flexible sleeve 1600 has been exhausted, the cartridge 400 may be replaced with a new cartridge and the continuous flexible sleeve may then be threaded or fed around the inner tube 420 and past the sealing mechanism 120. At such time, the sealing mechanism may then be applied to the continuous flexible sleeve to initially close or seal an end. The method may then return to its standard condition in which it monitors the system to determine whether a deposit of waste 1630 has been made (at 1540).

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A waste containment or disposal device comprising:
a sleeve source for providing a continuous flexible sleeve;
a sealing mechanism for permanently sealing a segment of the continuous flexible sleeve; and
a feed mechanism for advancing a length of the continuous flexible sleeve past the sealing mechanism;
wherein, upon placement of waste in a segment of the continuous flexible sleeve having a closed end advanced past the sealing mechanism by the feed mechanism, the sealing mechanism permanently seals the segment of the flexible sleeve.

2. The waste containment or disposal device of claim 1, wherein the continuous flexible sleeve comprises a fusible material, and wherein the sealing mechanism permanently seals the segment by fusing the fusible material.

3. The waste containment or disposal device of claim 2, wherein the sealing mechanism comprises a clamp and a heat source, and wherein, upon placement of the waste in the segment, the clamp compresses an opening of the segment against the heat source, and the heat source applies heat to fuse the clamped fusible material.

4. The waste containment or disposal device of claim 2, wherein the continuous flexible sleeve comprises a fusible plastic, and wherein the sealing mechanism melts an opening of the segment closed by applying heat to the fusible plastic.

5. The waste containment or disposal device of claim 1, wherein the feed mechanism comprises an inner tube and at least one outer roller, and wherein a cross section of the continuous flexible sleeve encloses the inner tube, and wherein the at least one outer roller grips the continuous flexible sleeve and the feed mechanism rotates the at least one roller to advance the continuous flexible sleeve relative to the inner tube.

6. The waste containment or disposal device of claim 5, wherein the at least one outer roller is motorized, and wherein after permanently sealing the segment of the flexible sleeve to form a sealed segment, the at least one outer roller advances the continuous flexible sleeve so as to locate a new segment of the flexible sleeve between the sealed segment and the sealing mechanism.

7. The waste containment or disposal device of claim 6, wherein the at least one outer roller advances the continuous flexible sleeve so as to locate the new segment only after determining that a lid of the waste disposal device has been opened.

8. The waste containment or disposal device of claim 1 wherein the feed mechanism comprises a cartridge support, wherein the sleeve source is a cartridge located at the cartridge support, and wherein the continuous flexible sleeve is drawn from the cartridge by the feed mechanism.

9. The waste containment or disposal device of claim 1 further comprising at least one sensor for determining when waste has been deposited into the segment of the continuous flexible sleeve.

10. The waste containment or disposal device of claim 1 further comprising a container defining a waste receiving chamber located such that a sealed segment advanced past the sealing mechanism is received in the waste receiving chamber.

11. The waste containment or disposal device of claim 10, wherein the sleeve source, sealing mechanism, and feed mechanism are located within the container and wherein the waste disposal device further comprises a lid for sealing to the container and enclosing the sleeve source, sealing mechanism, and feed mechanism.

12. The waste containment or disposal device of claim 11 further comprising a compacting mechanism, wherein the compacting mechanism compacts waste into the segment upon closure of the lid.

13. The waste containment or disposal device of claim 11 further comprising at least one interlock preventing the sealing mechanism from sealing the segment unless the lid is closed.

14. The waste containment or disposal device of claim 1 further comprising a vacuum assembly for extracting air from the segment prior to or during sealing of the segment by the sealing mechanism.

15. The waste containment or disposal device of claim 1, wherein the sleeve source is located opposite the sealing mechanism from the feed mechanism, and wherein during use the feed mechanism draws the continuous flexible sleeve past the sealing mechanism.

16. The waste containment or disposal device of claim 2, wherein the sealing mechanism applies pressure, and wherein, upon placement of the waste in the segment, the sealing mechanism compresses an opening of the segment to fuse the fusible material.

17. A method for containing or disposing of waste comprising:
providing a continuous flexible sleeve having a sealed end;
providing a sealing mechanism for sealing the continuous flexible sleeve;
providing a feed mechanism for advancing a length of the continuous flexible sleeve past the sealing mechanism;
determining that waste has been deposited within the continuous flexible sleeve adjacent the sealed end;
permanently sealing, by the sealing mechanism, an end of a segment of the continuous flexible sleeve between the sealing mechanism and the sealed end, thereby forming a newly sealed end;
advancing the continuous flexible sleeve by the feed mechanism such that the newly sealed end is spaced apart from the sealing mechanism by a new segment.

18. The method of claim 17, wherein the continuous flexible sleeve comprises a fusible material, and wherein permanently sealing the end of the segment of the continuous flexible sleeve comprises clamping the end of the segment against a heat source and applying heat to the fusible material at the heat source.

19. The method of claim 17, wherein the feed mechanism comprises an inner tube and at least one outer roller, and wherein a cross section of the flexible sleeve encloses the inner tube, and wherein advancing the continuous flexible sleeve comprises gripping the flexible sleeve at the at least one outer roller and sliding the flexible sleeve relative to the inner tube.

20. The method of claim 19, wherein determining that waste has been deposited is by detecting waste passing a sensor at the inner tube.

21. The method of claim 17, wherein the feed mechanism is located opposite the sealing mechanism from the segment, such that the feed mechanism dispenses the continuous flexible sleeve towards and past the sealing mechanism.

22. The method of claim 17, wherein the continuous flexible sleeve comprises a pressure fusible material, and wherein permanently sealing the end of the segment of the continuous flexible sleeve comprises applying pressure to the fusible material.
